(19) United States
(12) Patent Application Publication
(10) Pub. No.: US 2026/0143219 A1
(43) Pub. Date: May 21, 2026

(54) IMAGING SYSTEM ADJUSTMENT

(71) Applicant: MILWAUKEE ELECTRIC TOOL CORPORATION, Brookfield, WI (US)

(72) Inventors: Carl B. Westerby, Menomonee Falls, WI (US); Francisco J. Hernandez, Brookfield, WI (US); Christopher J. Turner, Lannon, WI (US)

(21) Appl. No.: 19/394,964

(22) Filed: Nov. 20, 2025

Related U.S. Application Data
(60) Provisional application No. 63/722,982, filed on Nov. 20, 2024.

(51) Int. Cl. H04N 23/50; H04N 23/56; H04N 23/63; H04N 23/66; H04N 23/68

(52) U.S. Cl. CPC H04N 23/555; H04N 23/56; H04N 23/63; H04N 23/66; H04N 23/6811; H04N 23/6812

(57) ABSTRACT

An imaging system including a reel device, a display device including a display portion, a cable portion, and a camera portion. The camera portion includes an inertial measurement unit, an image sensor, and an electronic processor. The electronic processor is configured to receive rotation data from the inertial measurement unit, adjust a rotation of an image captured by the image sensor based on rotation data and determine whether the rotation of the image causes undefined areas on the display portion. The undefined areas are where no image data is available for display.

### FIELD

The present application relates to an imaging device, such as a visual inspection device.

### SUMMARY

One implementation provides an imaging system including a reel device, a display device including a display portion, a cable portion, and a camera portion. The camera portion includes an inertial measurement unit, an image sensor, and an electronic processor. The electronic processor is configured to receive rotation data from the inertial measurement unit, adjust a rotation of an image captured by the image sensor based on rotation data, and determine whether the rotation of the image causes undefined areas on the display portion. The undefined areas are where no image data is available for display. The electronic processor is also configured to, in response to determining that the rotation of the image causes undefined areas on the display portion, crop the image to create a smaller image such that there are no undefined areas displayed.

Another implementation provides a method for adjusting an image captured by an image sensor based on an orientation of the image sensor. The method includes receiving rotation data from an inertial measurement unit included in a camera portion, adjust a rotation of an image captured by an image sensor included in a camera portion based on rotation data, and determining whether the rotation of the image causes undefined areas on a display portion of a display device. The undefined areas are where no image data is available for display. The method also includes, in response to determining that the rotation of the image causes undefined areas on the display portion, cropping the image to create a smaller image such that there are no undefined areas displayed.

Another implementation provides an imaging including a display device including a display portion, a cable portion, a camera portion including an inertial measurement unit and an image sensor, and a reel device. The reel device includes an electronic processor configured to receive rotation data from the inertial measurement unit, adjust a rotation of an image captured by the image sensor based on rotation data and determine whether the rotation of the image causes undefined areas on the display portion. The undefined areas are where no image data is available for display. The electronic processor is also configured to, in response to determining that the rotation of the image causes undefined areas on the display portion, crop the image to create a smaller image such that there are no undefined areas displayed.

### BRIEF DESCRIPTION OF THE DRAWINGS

FIGS. 1A-C is a perspective view of an imaging system, according to some implementations.

FIG. 2 is an example circuit diagram of a cable portion of the imaging system of FIG. 1A-C, in accordance with one implementation.

FIG. 3 is a cutaway of the cable portion of the imaging system of FIG. 1A-C, in accordance with one implementation.

FIG. 4 is a block diagram of the imaging system of FIG. 1A-C, in accordance with one implementation.

FIG. 5 is a block diagram of a camera portion of the imaging system of FIG. 1A-C, in accordance with one implementation.

FIG. 6A is an illustration of a virtual memory map utilized by the imaging system of FIG. 1A-C, in accordance with one implementation.

FIG. 6B is an illustration of data transmission between an electronic processor of a camera portion of the imaging system of FIG. 1A-C and an electronic processor of a control device of the imaging system of FIG. 1A-C, in accordance with one implementation.

FIG. 7 is a flowchart of a process for adjusting an image captured by an image sensor based on an orientation of the image sensor, in accordance with one implementation.

FIG. 8 is an example of capturing a smaller image, in accordance with one implementation.

### DETAILED DESCRIPTION

Before any embodiments are explained in detail, it is to be understood that the embodiments are not limited in their application to the details of construction and the arrangement of components set forth in the following description or illustrated in the following drawings. The embodiments may include other constructions and the arrangements of components and may be practiced or carried out in various ways. Also, the phraseology and terminology used herein is for the purpose of description and should not be regarded as limited. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting and coupling. Further, “connected” and “coupled” are not restricted to physical or mechanical connections or couplings, and can include electrical connections or couplings, whether direct or indirect.

It should be noted that a plurality of hardware and software-based devices, as well as a plurality of different structural components may be utilized to implement the disclosed embodiments. Furthermore, and as described in subsequent paragraphs, the specific configurations illustrated in the drawings are intended as example embodiments and that other alternative configurations are possible. The terms “processor” “central processing unit” and “CPU” are interchangeable unless otherwise stated. Where the terms “processor” or “central processing unit” or “CPU” are used as identifying a unit performing specific functions, it should be understood that, unless otherwise stated, those functions can be carried out by a single processor, or multiple processors arranged in any form, including parallel processors, serial processors, tandem processors or cloud processing/cloud computing configurations.

Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

It should also be understood that although certain drawings illustrate hardware and software located within particular devices, these depictions are for illustrative purposes only. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links.

Thus, in the claims, if an apparatus or system is claimed, for example, as including an electronic processor or other element configured in a certain manner, for example, to make multiple determinations, the claim or claim element should be interpreted as meaning one or more electronic processors (or other element) where any one of the one or more electronic processors (or other element) is configured as claimed, for example, to make some or all of the multiple determinations. To reiterate, those electronic processors and processing may be distributed.

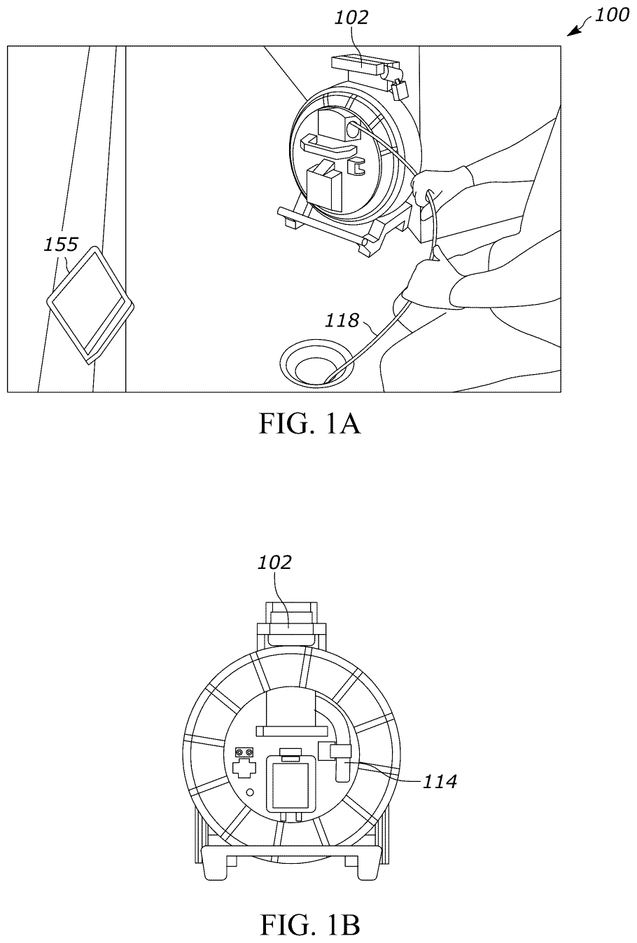

FIG. 1A-C is a system view of a pipe-line inspection system 100, having a reel device 102 and a camera portion 114 attached to the reel device 102 via a cable portion 118. The pipe-line inspection system 100 may include a display device 155 with a display portion 106, a user interface 108. FIG. 1C illustrates two possible examples of display devices 155 that may be included in the pipe-line inspection system 100. In some implementations, the display device 155 may communicate with the reel device 102 via a communication network including one or more wired or wireless communications. For example, the communication network may be implemented using a wide area network, for example, the internet, a Long-Term Evolution (LTE) network, a 4G network, 5G network, or one of their successors and/or one or more local area networks, for example, a Bluetooth™ network or Wi-Fi network.

The display portion 106 is configured to display images to a user. For example, the display portion 106 may be configured to display an image captured by the camera portion 114. Additional information, such as image metadata, temperature, and/or other parameters provided by the camera portion 114 may be displayed by the display portion 106. The user interface 108 may include one or more user inputs, such as push-buttons, touchscreens, scroll wheels, knobs, joysticks, and/or any other user input required for a given application. In some examples, a user may be able to access one or more menus associated with the reel device 102 and/or the camera portion 114, which may be displayed on the display portion 106.

The reel device 102 may further include a cavity for accepting a rechargeable battery pack. The rechargeable battery pack may be a power tool battery, such as 12V lithium-ion battery pack or the M18™ REDLITHIUM™ battery from Milwaukee Tool®. However, other battery voltages, such as 3.3V, 18V, 24V, 48V, 72V and/or other voltage required for a given application are also contemplated. Further, other battery chemistries, such as lithium-iron phosphate, nickel cadmium, alkaline, and/or other battery chemistries required for a given application are also contemplated.

As described above, a camera portion 114 may be located at a first end of the cable portion 118. The camera portion 114, as will be described in more detail below, may include one or more imaging sensors, a sonde, an inertial measurement unit (IMU), or other sensors as required for a given application. The camera portion 114 may further include other components, such as one or more LEDs for providing illumination for the image sensors.

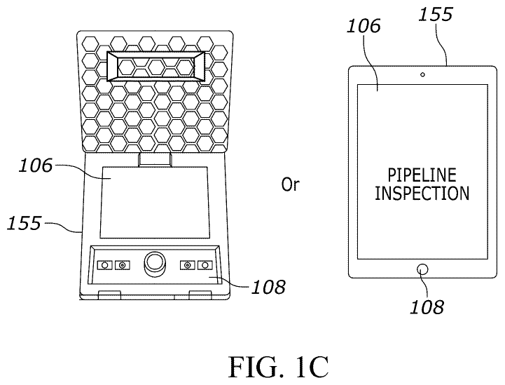

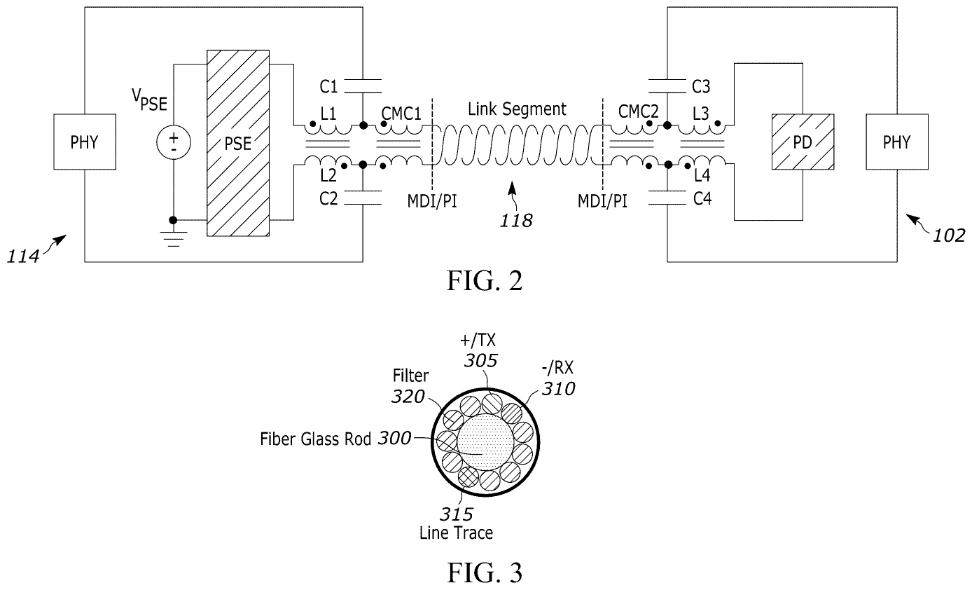

The cable portion 118 may generally be a semi-rigid cable to allow for manipulation of the camera portion 114 within an enclosed space. However, in other implementations, the cable portion 118 may be more pliable or more rigid, as required for a given application. The cable portion 118 may be variable in length depending on a desired application. In some implementations, the cable portion 118 includes two conductors (for example, a pair of wires or a shield and center wire), both conductors transmit data and power. For example, the cable portion 118 may include a power over dataline (PoDL) twisted pair or a power over coax. In some implementations, the cable portion 118 is a full-duplex cable that allows data to be transmitted in both directions simultaneously. FIG. 2 is an example circuit diagram of the cable portion 118 connecting the camera portion 114 and the reel device 102. FIG. 3 is a cutaway of the cable portion 118. In the example illustrated in FIG. 3, the cable portion includes, at its center, a fiberglass rod 300, a transmitter wire 305, a receiver wire 310, a line trace or tracer wire 315, and one or more filler wires 320.

While the above system 100 is described as being a pipe-line inspection system, it is understood that the implementations described herein may also be applicable to other imaging devices, such as borescope-type devices.

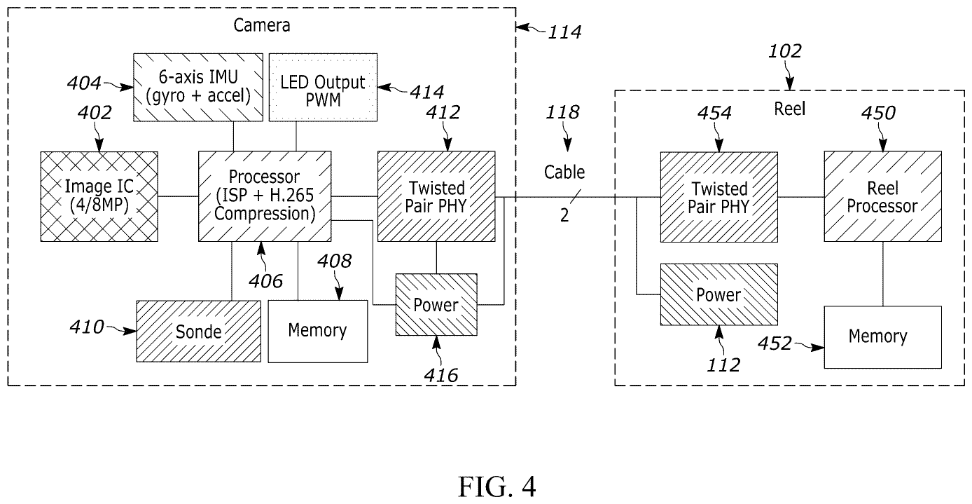

FIG. 4 illustrates a block diagram of the pipe-line inspection system 100. The camera portion 114 includes an image sensor 402, an IMU 404, an electronic processor 406, a memory 408, a sonde 410, an input/output interface 412, and an LED(s) 414. The camera portion 114 may also include a switching power supply 416. The switching power supply 416 may be supplied from the battery pack via the cable portion 118. The electronic processor 406 and other electrical components of the camera portion 114 may receive power from the switching power supply 416 and/or from the battery pack included in the reel device 102 via the cable portion 118.

The electronic processor 406 may be communicably connected to one or more of the image sensor 402, IMU 404, memory 408, sonde 410, input/output interface 412, and LED(s) 414. The electronic processor 406 may be implemented as a programmable microprocessor, an application specific integrated circuit (ASIC), one or more field programmable gate arrays (FPGA), a group of processing components, or with other suitable electronic processing components.

The memory 408 (for example, a non-transitory, computer-readable medium) includes one or more devices (for example, RAM, ROM, flash memory (for example, serial peripheral interface (SPI) flash memory), hard disk storage, etc.) for storing data and/or computer code for completing or facilitating the various processes, layers, and modules described herein. The memory 408 may include database components, object code components, script components, or other types of code and information for supporting the various activities and information structure described in the present application. According to one example, the memory 408 is communicably connected to the electronic processor 406 and may include computer code for executing (for example, by the electronic processor 406) one or more processes described herein.

The image sensor 402 may be a camera configured to capture 1 to 8 megapixel images. However, cameras capable of capturing images at more than 8 megapixels are also contemplated as required for a given application. In one example, the image sensor 402 may be the OS08A20 image sensor provided by OmniVision. In some implementations, the image sensor 402 includes an aperture that controls how much light enters the camera and the exposure of the image captured by the image sensor 402. In some implementations, the electronic processor 406 is configured to perform image signal processing, image compression, and the like. In some examples, the sonde 410 may be a radio transmitter. However, other sonde types are also contemplated as required for a given application. The IMU 404 may be a 6-axis IMU that includes an accelerometer and a gyroscope. However, the IMU 404 may also include more than 6-axes or less than 6-axes, as required for a given application.

In some examples, an LED(s) 414 provides illumination for the image sensors 402. In some implementations, the camera portion 114 includes multiple LEDs. The input/output interface 412 may allow the camera portion 114 to send data to and receive data from the reel device 102 via the cable portion 118. The input/output interface 412 may also allow the camera portion 114 to receive power from the battery pack 112. When the cable portion 118 includes a twisted pair, the input/output interface may be a twisted pair physical layer or interface (“PHY”).

In some implementations, the reel device 102 includes an electronic processor 450, a memory 452, and an input/output interface 454. The electronic processor 450, memory 452, and input/output interface 454 of the reel device 102 may be similar to the electronic processor 406, the memory 408, and the input/output interface 412 of the camera portion 114.

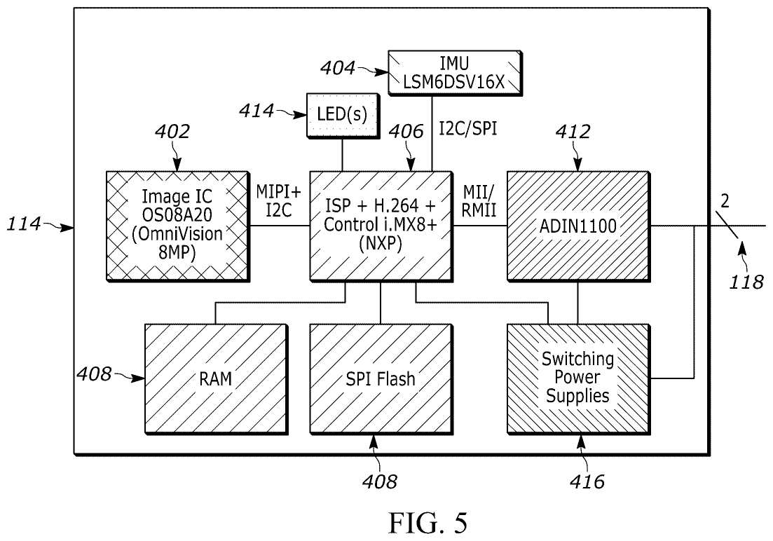

FIG. 5 provides another block diagram of the components of the camera portion 114 which includes a switching power supply 416 for providing power to one or more components of the camera portion 114. For example, the switching power supply 416 may be configured to output multiple voltages, such as ±3.3V, ±5VDC, ±12VDC, and or other voltages as required for a given application. The switching power supply 416 may include one or more of a buck converter, a boost converter, or a buck-boost converter to supply the required voltages.

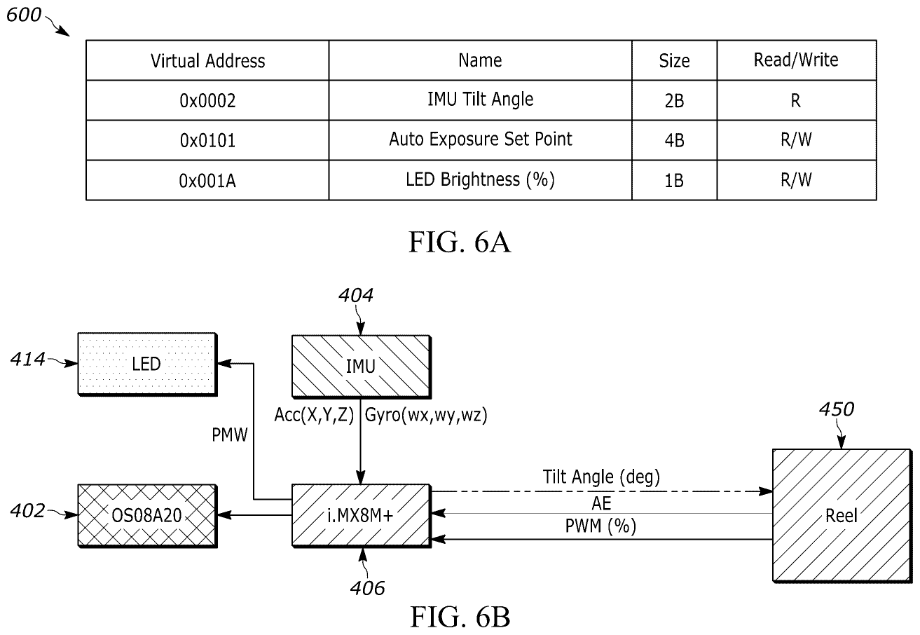

FIG. 6A provides an example of a virtual memory map 600 that may be stored in one or both of the memory 408 and the memory 452. The virtual memory map 600 may provide a framework for handling communication between the reel device 102 and the camera portion 114. For example, the virtual memory map 600 may store an agreement such that when a communication from the electronic processor 406 of the camera portion 114 or a communication from the electronic processor 450 of the reel device 102 refers to the location or address 0x0002 in memory, the communication refers to the tilt angle of the camera portion 114 (likewise, the address 0x0101 refers to the auto exposure set point and the address 0x001A refers to the brightness of the LED(s) 414). The electronic processor 450 may request the tilt angle determined by the IMU 404 by requesting to read the value stored at 0x0002 in the memory 408. Similarly, the electronic processor 450 may request that the electronic processor 406 change the functioning of the camera portion 114 by writing to an address. For example, the electronic processor 450 may write the value 100 to the address in the memory 408 associated with LED brightness (according to the virtual memory map 600, the address is 0x001A), to request that the electronic processor 406 run the LED(s) 414 at maximum output or brightness.

FIG. 6B provides an illustration of data that may be transmitted between the electronic processor 406 of the camera portion 114 and the electronic processor 450 of the reel device 102 via the cable portion 118. For example, the electronic processor 406 of the camera portion 114 may receive the tilt angle of the camera portion 114 from the IMU 404 and transmit the tilt angle to the electronic processor 450 of the reel device 102. In some implementations, the electronic processor 450 of the reel device 102 determines a desired exposure setting (an image signal processing setting) based on input received from the user interface 108 or a determination of the environment the camera portion 114 is in (for example, a white pipe or a black pipe). In some implementations, the electronic processor 406 of the camera portion 114 may receive a desired exposure setting from the electronic processor 450 of the reel device 102 and adjust or control the exposure settings (for example, an exposure time) of the image sensor 402 to achieve the desired exposure. In these implementations, the LED(s) 414 are set to 100 percent or full brightness. In other implementations, the electronic processor 406 of the camera portion 114 may receive a desired image light intensity for an image from the electronic processor 450 of the reel device 102 and control the pulse width modulation (PWM) of the LED(s) 414 to achieve the desired image light intensity. In some implementations, based on a communication from the reel device 102, the electronic processor 406 of the camera portion 114 may control the sonde 410 by turning the sonde 410 on and off and setting the transmission frequency of the sonde (for example, the transmission frequency of the sonde 410 may be 512 Hz, 640 Hz, 33 kHz, or the like).

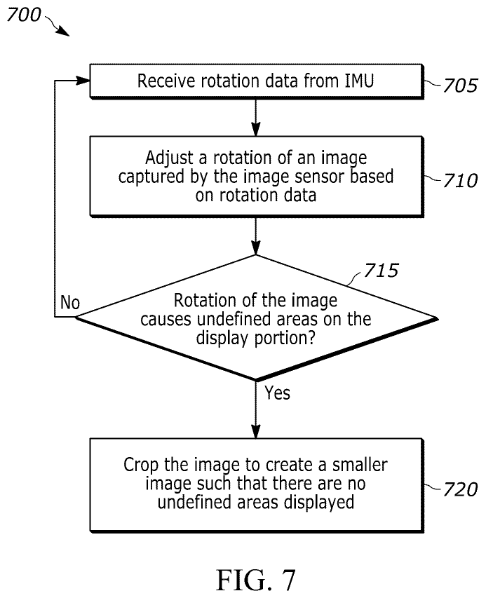

FIG. 7 provides a flowchart of a process 700 for adjusting an image captured by an image sensor based on an orientation of the image sensor. In some implementations, the process 700 is performed by the electronic processor 406 and the electronic processor 406 adjusts the rotation of the image captured by the image sensor 402. In other implementations, the process 700 is performed by the electronic processor 450 of the reel device 102 or an electronic processor (not illustrated) included in the display device 155. In some implementations, the process 700 begins at process block 705, when the electronic processor 406 receives rotation data from the IMU 404. At process block 710, the electronic processor 406 adjusts a rotation of an image captured by the image sensor 402 based on the rotation data. For example, the captured image may be rotated so that the captured image appears level on the display portion 106. However, as the image sensor 402 is rotated (e.g., 90 degrees) to adjust its orientation based on the rotation data, on the display portion 106 undefined areas may appear or be displayed where there is no image data or pixels available to be displayed. For example, the undefined areas may be displayed as “black” bars or boxes. At process block 715, the electronic processor 406 determines whether the orientation of the image sensor 402 causes or will cause undefined areas to be displayed on the display portion 106. In response to determining that the rotation of the image causes or will cause undefined areas to be displayed on the display portion 106, the electronic processor 406, at process block 720, crops or zooms the image captured by the image sensor 402 to create a smaller image such that there are no undefined areas displayed. In some implementations, the electronic processor 406 crops the captured image so that only pixels with light or an image of a pipe are displayed on the display portion 106.

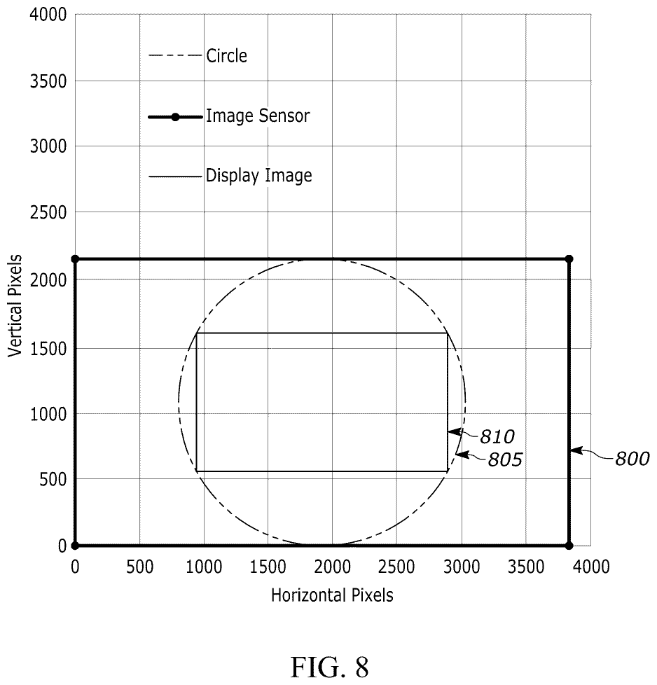

FIG. 8 provides an example of how a captured image may be adjusted so that a smaller image without undefined areas is displayed. The box 800 represents the original image captured by the image sensor 402. To eliminate the undefined areas on the display portion 106, the image captured by the image sensor 402 is trimmed or cropped so that the image data to be displayed is contained in an area identified as the circle 805. There are enough image data pixels (pixels including light or image data) to fill the circle 805. The box 810 represents the cropped image to be displayed on the display portion 106.

What is claimed is:

1. An imaging system comprising:
a reel device;
a display device including a display portion;
a cable portion; and
a camera portion, the camera portion comprising:
an inertial measurement unit;
an image sensor; and
an electronic processor configured to:
receive rotation data from the inertial measurement unit;
adjust a rotation of an image captured by the image sensor based on rotation data;
determine whether the rotation of the image causes undefined areas on the display portion, wherein the undefined areas are where no image data is available for display; and
in response to determining that the rotation of the image causes undefined areas on the display portion, crop the image to create a smaller image such that there are no undefined areas displayed.

2. The imaging system according to claim 1, wherein the cable portion includes at least two conductors for transmitting power and data.

3. The imaging system according to claim 1, wherein the electronic processor is further configured to:
receive a communication from the reel device; and
based on the received communication, adjust image signal processing settings, control one or more LEDs included in the camera portion, or control a sonde included in the camera portion.

4. The imaging system according to claim 1, wherein the reel device includes a memory storing a virtual memory map that provides a framework for handling communication between the reel device and the camera portion.

5. The imaging system according to claim 1, wherein the camera portion includes a memory storing a virtual memory map that provides a framework for handling communication between the reel device and the camera portion.

6. The imaging system according to claim 1, wherein the electronic processor is further configured to:
receive a desired image light intensity for an image from the reel device; and
control a pulse width modulation of one or more LEDs to achieve the desired image light intensity.

7. The imaging system according to claim 1, wherein the electronic processor is further configured to:
receive, from the reel device, a desired exposure setting based on input received from a user interface included in the display device or based on a determined environment for the camera portion; and
control an exposure setting of the image sensor to achieve the desired exposure setting.

8. The imaging system according to claim 1, wherein the cable portion is a full-duplex cable allowing data to be transmitted to and from the camera portion simultaneously.

9. The imaging system according to claim 1, wherein the camera portion is attached to the reel device via the cable portion.

10. The imaging system according to claim 1, wherein the display device communicates with the reel device via a communication network.

11. A method for adjusting an image captured by an image sensor based on an orientation of the image sensor, the method comprising:
receiving rotation data from an inertial measurement unit included in a camera portion;
adjusting a rotation of an image captured by an image sensor included in a camera portion based on rotation data;
determining whether the rotation of the image causes undefined areas on a display portion of a display device, wherein the undefined areas are where no image data is available for display; and
in response to determining that the rotation of the image causes undefined areas on the display portion, cropping the image to create a smaller image such that there are no undefined areas displayed.

12. The method according to claim 11, the method further comprising:
receiving a desired image light intensity for an image; and
controlling a pulse width modulation of one or more LEDs to achieve the desired image light intensity.

13. The method according to claim 11, the method further comprising:
receiving a desired exposure setting based on input received from a user interface included in the display device or based on a determined environment for the camera portion; and
controlling an exposure setting of the image sensor to achieve the desired exposure setting.

14. An imaging system comprising:
a display device including a display portion;
a cable portion;
a camera portion including an inertial measurement unit and an image sensor; and
a reel device, the reel device comprising:
an electronic processor configured to:
receive rotation data from the inertial measurement unit;
adjust a rotation of an image captured by the image sensor based on rotation data;
determine whether the rotation of the image causes undefined areas on the display portion, wherein the undefined areas are where no image data is available for display; and
in response to determining that the rotation of the image causes undefined areas on the display portion, crop the image to create a smaller image such that there are no undefined areas displayed.

15. The imaging system according to claim 14, wherein the cable portion includes at least two conductors for transmitting power and data.

16. The imaging system according to claim 14, wherein the reel device includes a memory storing a virtual memory map that provides a framework for handling communication between the reel device and the camera portion.

17. The imaging system according to claim 14, wherein the camera portion includes a memory storing a virtual memory map that provides a framework for handling communication between the reel device and the camera portion.

18. The imaging system according to claim 14, wherein the cable portion is a full-duplex cable allowing data to be transmitted to and from the camera portion simultaneously.

19. The imaging system according to claim 14, wherein the camera portion is attached to the reel device via the cable portion.

20. The imaging system according to claim 14, wherein the display device communicates with the reel device via a communication network.
